(19) United States
(12) Patent Application Publication
(10) Pub. No.: US 2004/0199919 A1
(43) Pub. Date: Oct. 7, 2004

(54) Methods and apparatus for optimal OpenMP application performance on Hyper-Threading processors

(76) Inventor: Vasanth R. Tovinkere, Portland, OR (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/407,384

(22) Filed: Apr. 4, 2003

(51) Int. Cl. G06F 9/46

(52) U.S. Cl. 718/102

(57) ABSTRACT

Methods and apparatus for Optimal OpenMP application performance on Hyper-Threading processors are disclosed. For example, an OpenMP runtime library is provided for use in a computer having a plurality of processors, each architecturally designed with a plurality of logical processors, and Hyper-Threading enabled. The example OpenMP runtime library is adapted to determine the number of application threads requested by an application and assign affinity to each application thread if the total number of executing threads is not greater than the number of physical processors. A global status indicator may be utilized to coordinate the assignment of the application threads.

### TECHNICAL FIELD

The present disclosure relates to compiler directives and associated Application Program Interface (API) calls and, more particularly, to methods and apparatuses for optimal OpenMP application performance on Hyper-Threading processors.

### BACKGROUND

Hyper-Threading technology enables a single processor to execute two separate code streams (called threads) concurrently. Architecturally, a processor with Hyper-Threading technology consists of two logical processors, each of which has its own architectural state, including data registers, segment registers, control registers, debug registers, and most of the Model Specific Register (MSR). Each logical processor also has its own advanced programmable interrupt controller (APIC). After power up and initialization, each logical processor can be individually halted, interrupted, or directed to execute a specified thread, independently from the other logical processor on the chip. Unlike a traditional dual processor (DP) configuration that uses two separate physical processors, the logical processors in a processor with Hyper-Threading technology share the execution resources of the processor core, which include the execution engine, the caches, the system bus interface, and the firmware.

Hyper-Threading technology is designed to improve the performance of traditional processors by exploiting the multi-threaded nature of contemporary operating systems, server applications, and workstation applications in such a way as to increase the use of the on-chip execution resources. Virtually all contemporary operating systems (including, for example, Microsoft® Windows®)) divide their work load up into processes and threads that can be independently scheduled and dispatched to run on a processor. The same division of work load can be found in many high-performance applications such as database engines, scientific computation programs, engineering-workstation tools, and multi-media programs.

To gain access to increased processing power, some contemporary operating systems and applications are also designed to be executed in dual processor (DP) or multi processor (MP) environments, where, through the use of symmetric multiprocessing (SMP), processes and threads can be dispatched to run on a pool of processors. When placed in DP or MP systems, the increase in computing power will generally scale linearly as the number of physical processors in a system is increased.

OpenMP is an industry standard of expressing parallelism in an application using a set of compiler directives and associated Application Program Interface (API) calls. With the advent of Hyper-Threading technology, more users are being exposed to multiple processor machines as their primary desktop workstations and more operating systems, server applications, and workstation applications are being written to take advantage of the performance gains associated with the Hyper-Threading architecture.

OpenMP support is provided through a number of compilers, including C, C++ and FORTRAN compilers, as well as threaded libraries, such as Math Kernel Libraries (MKL). Current versions of compilers and threaded libraries use a version of OpenMP runtime libraries that default to the operating system for scheduling the parallel OpenMP threads on the processor.

When OpenMP applications are run on systems with multiple Hyper-Threading processors, the increase in computing power should be similar to DP or MP systems and generally scale linearly as the number of physical processors in a system is increased. In practice, however, linear scaling may not necessarily occur when OpenMP applications are run on systems with multiple Hyper-Threading technology processors with the number of OpenMP threads equal to or less than the number of physical processors and when the scheduling of the parallel OpenMP threads is controlled by the operating system. The reason for this behavior is that the operating system may schedule individual threads on the logical processors that are in the same physical processor, allowing some physical processors to have multiple logical processors utilized, while other physical processors have no logical processors utilized.

### BRIEF DESCRIPTION OF THE DRAWINGS

FIG. 1 is a block diagram of a computer system illustrating an example environment of use for the disclosed methods and apparatus.

FIG. 2 is a block diagram of an example apparatus for optimal OpenMP application performance on Hyper-Threading processors.

FIG. 3 is a block diagram of an example application with multiple parallel regions.

FIG. 4, is a flowchart of an example program executed by the computer system of FIG. 1 to implement the apparatus of FIG. 2.

FIG. 5 is an example pseudo-code application which may be utilized in the application of FIG. 3.

FIG. 6 is example pseudo-code which may be utilized in programming an OpenMP runtime library utilized in the apparatus of FIG. 2.

FIG. 7 is example pseudo-code which may be utilized in programming an OpenMP runtime library utilized in the apparatus of FIG. 2.

### DETAILED DESCRIPTION

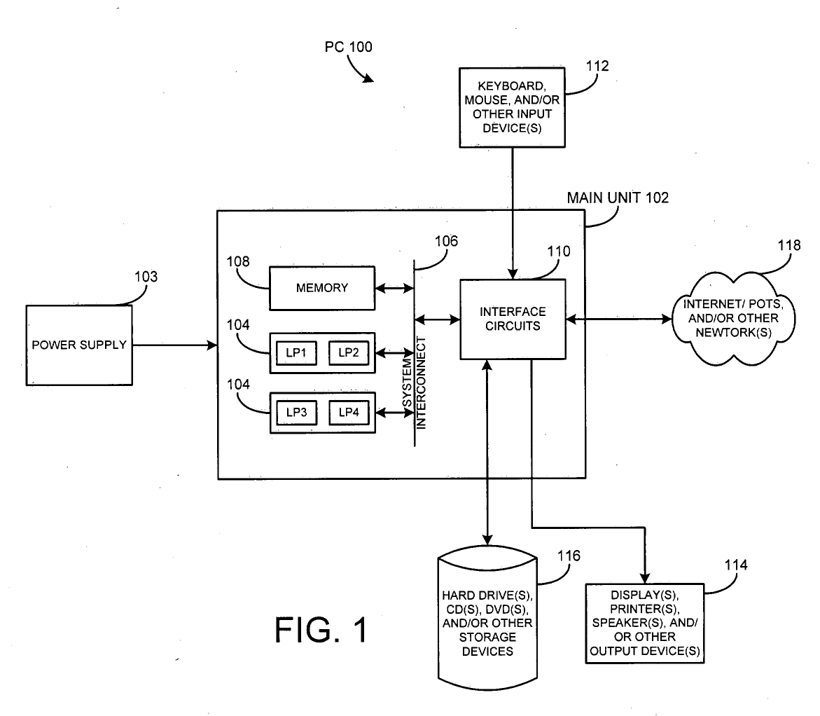

A block diagram of an example computer system 100 is illustrated in FIG. 1. The computer system 100 may be a personal computer (PC) or any other computing device capable of executing a software program. In an example, the computer system 100 includes a main processing unit 102 powered by a power supply 103. The main processing unit 102 illustrated in FIG. 1 includes two or more processors 104 electrically coupled by a system interconnect 106 to one or more memory device(s) 108 and one or more interface circuits 110. In an example, the system interconnect 106 is an address/data bus. Of course, a person of ordinary skill in the art will readily appreciate that interconnects other than busses may be used to connect the processors 104 to the memory device(s) 108. For example, one or more dedicated lines and/or a crossbar may be used to connect the processors 104 to the memory device(s) 108.

The processors 104 may include any type of well known Hyper-Threading enabled microprocessor, such as a microprocessor from the Intel® Pentium® 4 family of microprocessors, the Intel® Xeon™ family of microprocessors and/or any future developed Hyper-Threading enabled family of microprocessors. The processors 104 include a plurality of logical processors LP1, LP2, LP3, LP4. While each processor 104 is depicted with two logical processors, it will be understood by one of ordinary skill in the art that each of the processors 104 may have any number of logical processors as long as at least two logical processors are present. Furthermore, the processors 104 may be constructed according to the IA-32 Intel® Architecture as is known in the art, or other similar logical processor architecture. Still further, while the main processing unit 102 is illustrated with two processors 104, it will be understood that any number of processors 104 may be utilized.

The illustrated main memory device 108 includes random access memory such as, for example, dynamic random access memory (DRAM), but may also include non-volatile memory. In an example, the memory device(s) 108 store a software program which is executed by one or more of the processors 104 in a well known manner.

The interface circuit(s) 110 is implemented using any type of well known interface standard, such as an Ethernet interface and/or a Universal Serial Bus (USB) interface. In the illustrated example, one or more input devices 112 are connected to the interface circuits 110 for entering data and commands into the main processing unit 102. For example, an input device 112 may be a keyboard, mouse, touch screen, track pad, track ball, isopoint, and/or a voice recognition system.

In the illustrated example, one or more displays, printers, speakers, and/or other output devices 114 are also connected to the main processing unit 102 via one or more of the interface circuits 110. The display 114 may be a cathode ray tube (CRT), a liquid crystal display (LCD), or any other type of display. The display 114 may generate visual indications of data generated during operation of the main processing unit 102. For example, the visual indications may include prompts for human operator input, calculated values, detected data, etc.

The illustrated computer system 100 also includes one or more storage devices 116. For example, the computer system 100 may include one or more hard drives, a compact disk (CD) drive, a digital versatile disk drive (DVD), and/or other computer media input/output (I/O) devices.

The illustrated computer system 100 may also exchange data with other devices via a connection to a network 118. The network connection may be any type of network connection, such as an Ethernet connection, digital subscriber line (DSL), telephone line, coaxial cable, etc. The network 118 may be any type of network, such as the Internet, a telephone network, a cable network, and/or a wireless network.

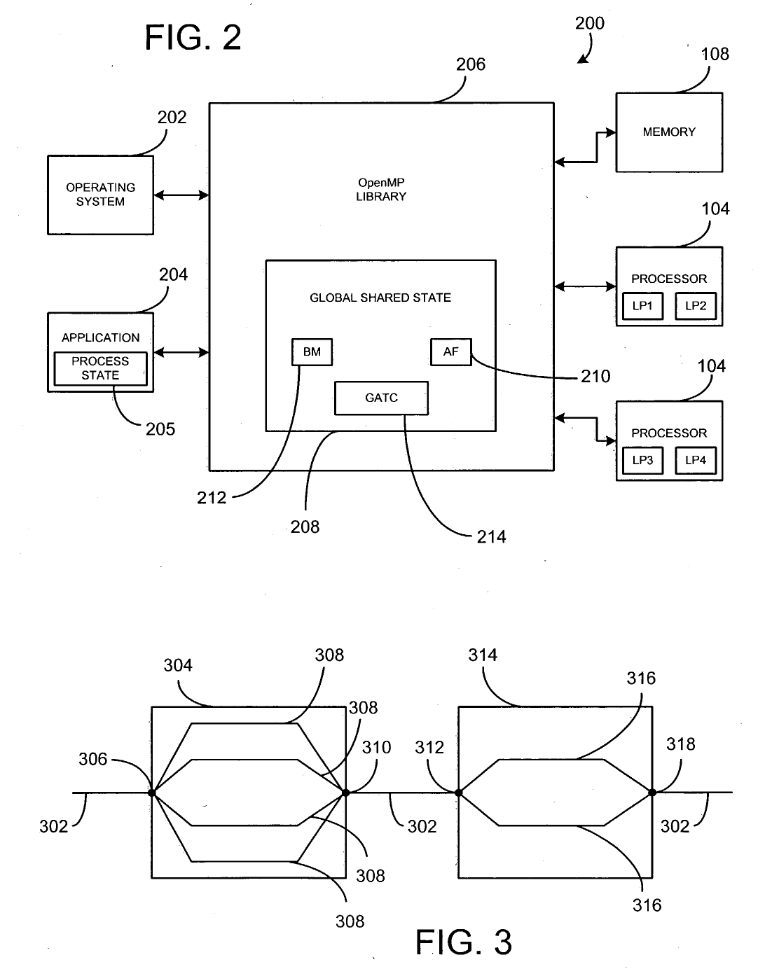

An example apparatus for optimal OpenMP application performance on Hyper-Threading processors is illustrated in FIG. 2 and is denoted by the reference numeral 200. Preferably, the apparatus 200 includes an operating system 202, an application 204, an OpenMP runtime library 206, the memory device(s) 108, and a plurality of processors 104. Any or all of the operating system 202, the application 204, and the OpenMP runtime library 206 may be implemented by conventional electronic circuitry, firmware, and/or by a microprocessor executing software instructions in a well known manner. However, in the illustrated example, the operating system 202, the application 204, and the OpenMP runtime library 206 are implemented by software executed by at least one of the processors 104. The memory device(s) 108 may be implemented by any type of memory device including, but not limited to, dynamic random access memory (DRAM), static random access memory (SRAM), and/or non-volatile memory. In addition, a person of ordinary skill in the art will readily appreciate that certain modules in the apparatus shown in FIG. 2 may be combined or divided according to customary design constraints. Still further, one or more of the modules may be located external to the main processing unit 102.

In the illustrated example, the operating system 202 is executed by at least one of the processors 104. The operating system 202 may be, for example, Microsoft® Windows® Windows 2000, or Windows .NET, marketed by Microsoft Corporation, of Redmond, Wash. The operating system 202 is adapted to control the execution of computer instructions stored in the operating system 202, the application 204, the OpenMP runtime library 206, the memory 108, or other device.

In the illustrated example, the application 204 is a set of computer programming instructions designed to perform a specific function directly for the user or, in some cases, for another application program. For example, the application may comprise a word processor, a database program, a computational program, a Web browser, a set of development tools, and/or a communication program. The application 204 may be written in the C programming language, or alternatively, it may be written in any other language, such as C++, FORTRAN or the like. Furthermore, the application 204 may comprise a process state 205 which indicates the affinity of the application 204, as described below.

The OpenMP runtime library 206 may be comprised of three Application Program Interface (API) components that are used to direct multi-threaded application programs. For instance, the OpenMP runtime library 206 may be comprised of compiler directives, runtime library routines, and environment variables (not shown) as is well known in the art. OpenMP uses an explicit programming model, allowing the application 204 to retain full control over parallel processing. The OpenMP runtime library 206 may be programmed in substantial compliance with official OpenMP specifications, for example, the OpenMP C and C++ Application Program Interface Standard, the OpenMP Architecture Review Board, version 2.0, published March 2002, and the OpenMP FORTRAN Application Program Interface Standard, the OperMP Architecture Review Board, version 2.0, published November 2000.

The OpenMP runtime 206 library may additionally comprise a Global Shared State 208 which maintains a global state for the system. The Global Shared State 208 additionally comprises an affinity flag (AF) 210, a bit mask (BM) 212, and a global active OpenMP thread count (GATC) 214. Each of the components 208, 210, 212, 214 will be described in detail below. It will also be appreciated that the Global Shared State 208 may be located external to the OpenMP runtime library 206.

Turning to FIG. 3, there is illustrated an example model 300 of the application 204 as executed on the processors 104, wherein the application 204 utilizes multiple threads. As illustrated, the application 204 is processed in cooperation with at least one of the processors 104 by initiating a master thread 302. The master thread 302 is executed by the processors 104 as a single thread. The application 204 may initiate a parallel region 304 (i.e., multiple concurrent threads). The application 204 contains a FORK directive 306, which creates multiple parallel threads 308. The parallel threads 308 are executed in parallel on the processors 104, utilizing the logical processors LP1, LP2, LP3, LP4.

The number of parallel threads 308 can be determined by default, by setting the number of threads environment variable within the operating system 202, or by dynamically setting the number of threads in the OpenMP runtime library 206 as are well known. It will be further understood that the number of threads for any parallel region 304 may be dynamically set, and do not necessarily have to be equal between parallel regions.

Once the execution of the parallel threads 308 is completed, the parallel threads 308 in the parallel region 304 are synchronized and terminated at a JOIN region 310, leaving only the master thread 302. The execution of the master thread 302 may then continue until the application 204 encounters another FORK directive 312, which will initiate another parallel region 314, by spawning another plurality of parallel threads 316. The parallel threads 316 are again executed in parallel on the processors 104, utilizing the logical processors LP1, LP2, LP3, LP4. Once the execution of the parallel threads 316 is completed, the parallel threads 316 in the parallel region 314 are synchronized and terminated at a JOIN region 310, leaving only the master thread 302. A person of ordinary skill in the art will readily appreciate that the application 204 may be written with any number of parallel regions, and any number of supported parallel threads in each parallel region according to customary design constraints.

Turning once again to FIG. 2, in the illustrated example apparatus 200, the performance of the parallel regions 304, 314 of the application 204 on the Hyper-Threading processors 104 is optimized. The illustrated application 204 invokes the OpenMP runtime library 206, both prior to and during execution. The OpenMP runtime library 206 coordinates with the operating system 202 to execute the application on the processors 104. To optimize the application 204 on the Hyper-Threading processors 104, the OpenMP runtime library 206 comprises an algorithm which may be invoked upon each encounter of an application FORK directive 306, 312.

Once the application 204 invokes the FORK directive 306, 312, the OpenMP runtime library 206 detects the number of requested parallel threads 308, 316 and allocates the threads 308, 316 on the processors 104 accordingly. Specifically, the OpenMP runtime library 206 will allocate the threads 308, 316 across the logical processors LP1, LP2, LP3, LP4 by utilizing the affinity flag (AF) 210 which indicates whether affinity, (i.e., associating a particular application thread with a particular processor) and the bit mask (BM) 212, which keeps track of the allocated processors 104 for affinity settings.

As will be appreciated, multiple applications 204 may be executed by the processors 104 at any point in time. Therefore, the OpenMP runtime library 206 keeps track of the total number of threads, including all master and parallel threads, in use by the processors 104 by updating the global active OpenMP thread count (GATC) 214. The OpenMP runtime library 206 enables affinity settings only when the number of active threads in the system is less than the number of physical processors 104.

An example manner in which the system of FIG. 2 may be implemented is described below in connection with a flow chart which represents a portion or a routine of the OpenMP runtime library 206, implemented as a computer program. The computer program portions are stored on a tangible medium, such as in one or more of the memory device(s) 108 and executed by the processors 104.

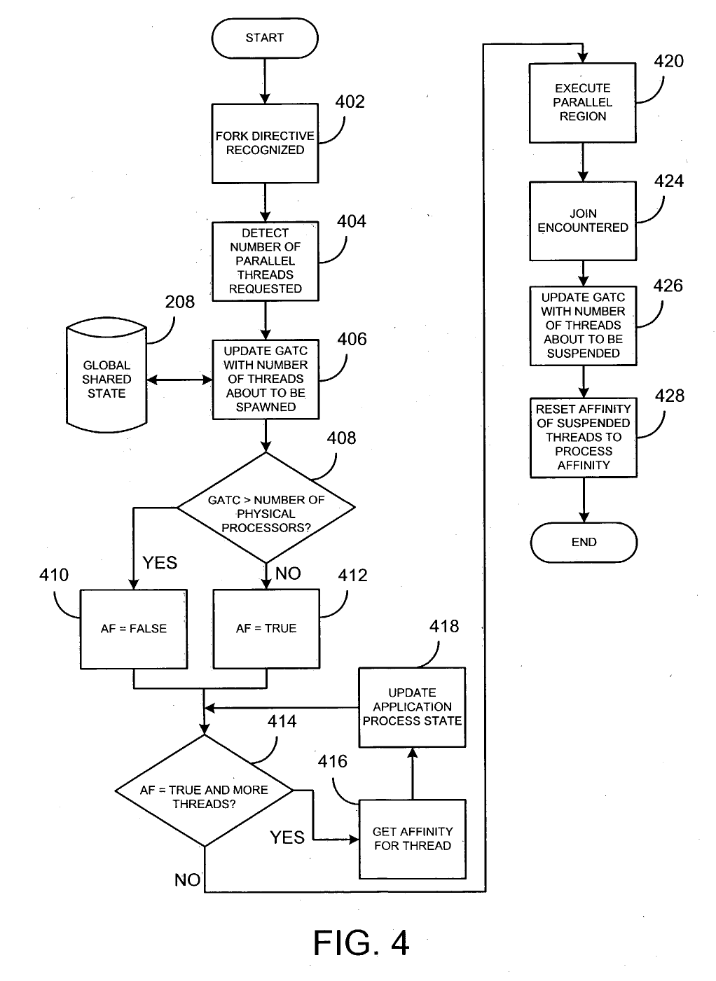

An example program for optimizing OpenMP application performance on hyper-threading processors is illustrated in FIG. 4. Initially, the OpenMP runtime library 206 recognizes the FORK directive 306, 312 being invoked by the application 204 (block 402). As described above, the FORK directive 306, 312 spawns a plurality of threads 308, 316 and initiates the parallel region 304, 314. The OpenMP runtime library 206 detects the number of requested parallel threads 308, 316 (block 404). The OpenMP runtime library 206 then updates the global active OpenMP thread count (GATC) 214 to reflect the addition of the number of requested threads 308, 316 (block 406).

Once updated to reflect the total number of active threads, the OpenMP runtime library 206 determines whether the global active OpenMP thread count (GATC) 214 is greater than the number of physical processors 104 (block 408). If the global active OpenMP thread count (GATC) 214 is greater than the number of physical processors, the OpenMP runtime library 206 will set the affinity flag (AF) 210 to false (block 410), otherwise, the affinity flag (AF) 210 will be set to true (block 412).

Upon setting the affinity flag (AF) 210, the OpenMP runtime library 206 will determine whether it needs to assign affinity to each requested thread by checking whether the affinity flag (AF) 210 is set to true and whether there are threads which have not been assigned affinity (block 414). If the OpenMP runtime library 206 determines that affinity must be assigned, the OpenMP runtime library 206 gets an affinity address from the bit mask (BM) 212 and stores the allocated affinity mask in the application process state 205 (blocks 416, 418). The OpenMP runtime library 206 will loop through the affinity allocation loop (blocks 416, 418) until all threads have been properly assigned.

Once all the threads have been assigned affinity, or once the OpenMP runtime library 206 determines that the affinity flag (AF) 210 is set to true, the application 204 spawns the parallel threads 308, 316 and the parallel regions 304, 314 are executed (block 420). In the disclosed application example of FIG. 3, the OpenMP runtime library 206 will not set affinity for the threads 308, since the number of threads 308 is greater than the number of processors 104, which in the example apparatus 200 is two. The threads 308 may then be scheduled by the operating system 202 to be processed on any available logical processor LP1, LP2, LP3, LP4, regardless of which physical processor 104 each logical processor LP1, LP2, LP3, LP4, resides on.

However, affinity may be set for the threads 316 if the there are no other threads operating on the processors 104, i.e., the two threads 316 are the only two threads executing on the processors 104. In this instance, the OpenMP runtime library 206 will assign affinity to each thread 316 and the two threads 316 will be forced to execute on the logical processors LP1, LP2, LP3, LP4, located on separate physical processors 104 (e.g., LP1 and LP3).

The execution of the parallel regions 304, 314 will continue on their respectively assigned logical processors LP1, LP2, LP3, LP4, until the OpenMP runtime library 206 recognizes the initialization of the JOIN region 310, 318 (block 424). As described above, the JOIN region 310, 318 synchronizes and terminates the threads 308, 316 leaving only the master thread 302. The OpenMP runtime library 206 then updates the global active OpenMP thread count (GATC) 214 to reflect the deletion of the terminated threads 308, 316 (block 426). The OpenMP runtime library 206 will then reset the bit mask (BM) 212 and the application process state 205 (block 428), wherein the execution of master thread 302 of the application 204 will continue with process affinity.

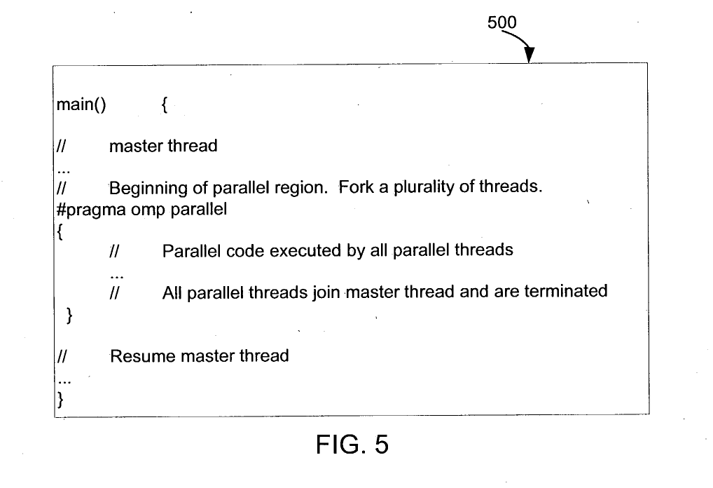

Turning to FIG. 5, there is illustrated an example of pseudo-code which may be included in the application 204 to invoke a Hyper-Threading parallel region 304 as described in connection with FIG. 3. Specifically, as shown in FIG. 5, a pseudo-C/C++ main program 500 is shown. The main program 600 contains a master thread which executes until a parallel region is initiated. The parallel region may be initiated using the valid OpenMP directive “#pragma omp parallel”. It will be appreciated that the OpenMP directive may be any known OpenMP directive, as is known in the art. The main program 600 then contains code which is executed by all parallel threads. The parallel threads are then joined and terminated, leavening only the master thread to continue execution.

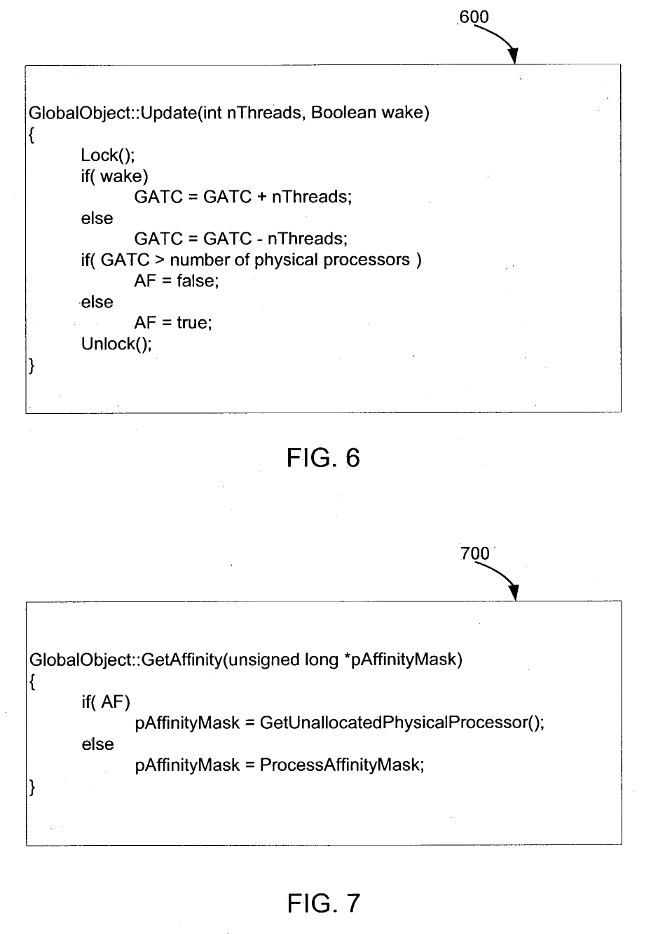

Turning to FIGS. 6 and 7, there are illustrated examples of C/C++ code which may be used in conjunction with the blocks 406, 426, as described above. Specifically, as shown in FIG. 6, an update object 600 is shown. The update object is defined as a global object (GlobalObject) which accepts parameters from the OpenMP runtime library 206. The update object 600 accepts the number of threads 308, 316 from the OpenMP runtime library 206 and whether the threads are to be spawned or terminated. The update object 600 then updates the global active OpenMP thread count (GATC) 214 by either increasing the thread count, if the threads are to be spawned (block 406), or decreasing the thread count, if the threads are to be terminated (block 426).

Turning to FIG. 7, a sample affinity object 700 is illustrated which may be used in conjunction with blocks 416, 418. As shown, the affinity object 700 contains C/C++ code which is defined as a global object (GlobalObject) which accepts an affinity mask parameter. The affinity object 700 will assign the affinity mask parameter an unallocated physical processor if the affinity flag (AF) 210 is set to true. If the affinity flag (AF) 210 is not set to true, the affinity mask parameter is assigned process affinity.

Although certain examples have been disclosed and described herein in accordance with the teachings of the present invention, the scope of coverage of this patent is not limited thereto. On the contrary, this patent covers all embodiments of the teachings of the invention fairly falling within the scope of the appended claims, either literally or under the doctrine of equivalents.

What is claimed is:

1. A method for assigning OpenMP software application threads executed by multiple physical processors, each physical processor having at least two logical processors, the method comprising:
maintaining a global thread count, wherein the global thread count is adapted to reflect the number of active threads being executed by the multiple physical processors;
executing an application parallel region, wherein the application parallel region comprises a plurality of OpenMP software application threads; and
assigning affinity to each of the plurality of OpenMP software application threads if the global thread count is not greater than the number of physical processors, whereby each of the physical processors executes no more than one of the plurality of OpenMP software application threads.

2. A method as defined in claim 1, further comprising maintaining an affinity flag, wherein the affinity flag is true if the global thread count is not greater than the number of physical processors.

3. A method as defined in claim 1, further comprising maintaining a bit mask, wherein the bit mask is adapted to reflect which of the logical processors is executing each of the plurality of OpenMP software application threads.

4. A method as defined in claim 1, wherein the application parallel region comprises at lease one of a C and C++ program.

5. A method as defined in claim 1, wherein the application parallel region comprises a FORTRAN program.

6. A method as defined in claim 1, wherein each of the physical processors are IA-32 Intel® architecture processors.

7. A method for assigning OpenMP software application threads executed by multiple physical processors, each physical processor having at least two logical processors, the method comprising:
maintaining a global thread count, wherein the global thread count is adapted to reflect the number of active threads being executed by the multiple physical processors;
initializing an application parallel region, wherein the application parallel region comprises a plurality of OpenMP software application threads;
updating the global thread count to reflect the addition of the plurality of OpenMP software application threads;
assigning affinity to each of the plurality of OpenMP software application threads if the global thread count is not greater than the number of physical processors, whereby each physical processor is assigned no more than one of the plurality of OpenMP software application threads;
executing the application parallel region on the physical processors;
terminating the execution of the application parallel region; and
updating the global thread count to reflect the termination of the plurality of OpenMP software application threads.

8. A method as defined in claim 7, further comprising maintaining an affinity flag, wherein the affinity flag is true if the global thread count is not greater than the number of physical processors.

9. A method as defined in claim 7, further comprising maintaining a bit mask, wherein the bit mask is adapted to reflect which of the logical processors is executing each of the plurality of OpenMP software application threads.

10. A method as defined in claim 7, further comprising maintaining an application process state, wherein the application process state is adapted to store the assigned affinity for each of the plurality of OpenMP software application threads.

11. A method as defined in claim 7, wherein the application parallel region comprises at least one of a C and C++ program.

12. A method as defined in claim 7, wherein the application parallel region comprises a FORTRAN program.

13. A method as defined in claim 7, wherein each of the physical processors are IA-32 Intel® architecture processors.

14. For use in a computer having a plurality of physical processors executing an application having at least one region comprising a plurality of application threads, an apparatus comprising:
a global thread counter, wherein the global thread counter is adapted to reflect the number of application threads being executed by the plurality of physical processors;
a plurality of logical processors, wherein each of the plurality of physical processors comprises at least two logical processors;
an OpenMP runtime library responsive to the execution of the plurality of application threads, the OpenMP runtime library adapted to update the global thread counter with a count of the number of application threads being executed by the plurality of physical processors, and the OpenMP runtime library adapted to assign physical processor affinity to each of the number of application threads being executed by the plurality of physical processors, if the number of application threads being executed by the plurality of physical processors is not greater than the number of physical processors.

15. An apparatus as defined in claim 14, further comprising an affinity flag, wherein the affinity flag is true if the number of application threads being executed by the plurality of physical processors is not greater than the number of processors.

16. An apparatus as defined in claim 14, further comprising a bit mask, wherein the bit mask is adapted to reflect the assignment of the physical processor affinity to each of the number of application threads being executed by the plurality of physical processors.

17. An apparatus as defined in claim 14, further comprising an application process state, wherein the application process state is adapted to store the assigned affinity each of the number of application threads being executed by the plurality of physical processors.

18. An apparatus as defined in claim 14, wherein each of the plurality of physical processors is an IA-32 Intel® architecture processor, and wherein each of the plurality of physical processors has two logical processors.

19. A computer-readable storage medium containing a set of instructions for a general purpose computer comprising a plurality of physical processors each physical processor comprising a plurality of logical processors, and a user interface comprising a mouse and a screen display, the set of instructions comprising:
an OpenMP runtime routine operatively associated with the plurality of physical processor to execute a plurality of application instruction threads on the plurality of logical processors, wherein each of the plurality of physical processors executes one application instruction threads if the number of application instruction threads is not greater than the number of plurality of physical processors.

20. A set of instructions as defined in claim 19, further comprising a global thread count storage routine operatively associated with the OpenMP runtime routine to store the number of application instruction threads executing on the plurality of physical processors.

21. A set of instruction as defined in claim 20, further comprising an affinity flag storage routine operatively associated with the global thread count storage routine and the OpenMP runtime routine to indicate whether the number of application instruction threads executing on the plurality of physical processors is greater than the number of physical processors.

22. A set of instructions as defined in claim 21, further comprising an application process state storage routine operatively associated with the OpenMP runtime routine to store an indication of which of the plurality of logical processors each of the application instruction threads is executing on.

23. A set of instruction as defined in claim 22, further comprising a bit mask storage routine operatively associated with the OpenMP runtime routine to store to store an indication of which of the plurality of logical processors has at least one of the application instruction threads executing on each of the plurality of logical processors.

24. A set of instructions as defined in claim 20, further comprising a global thread count update routine operatively associated with the OpenMP runtime routine and the global thread count storage routine to update the global thread count storage routine with the number of application instruction threads executing on the plurality of physical processors.

25. An apparatus comprising:
an input device;
an output device;
a memory; and
a plurality of physical processors, each having a plurality of logical processors, the plurality of physical processors cooperating with the input device, the output device and the memory to substantially simultaneously execute a plurality of application threads on separate physical processors when the number of executing application threads is not greater than the number of physical processors.

26. An apparatus as defined in claim 25, further comprising an OpenMP runtime library executing on the plurality of processors to initiate the execution of the plurality of application threads on separate physical processors.

27. An apparatus as defined in claim 25, further comprising:
a global thread count data file stored in the memory, the global thread count data file comprising data regarding the number of the plurality of application threads executing on the physical processors.
